(19) United States
(12) Patent Application Publication
(10) Pub. No.: US 2021/0386173 A1
(43) Pub. Date: Dec. 16, 2021

(54) STIRRING-EXTRUSION TYPE HAIR DYEING COMB

(71) Applicant: DONG GUAN KONG ELECTRIC ELECTRICAL APPLIANCES CO., LTD, Dongguan City (CN)

(72) Inventor: WingHan Wong, Dongguan City (CN)

(21) Appl. No.: 17/038,240

(22) Filed: Sep. 30, 2020

(30) Foreign Application Priority Data
Jun. 11, 2020 (CN) 2020105269414

(51) Int. Cl. A45D 19/02; A45D 24/00; A45D 24/22

(52) U.S. Cl. CPC A45D 19/02; A45D 2019/0091; A45D 24/22; A45D 24/007

(57) ABSTRACT

The invention discloses a stirring-extrusion type hair dyeing comb includes a hair dyeing comb enclosure. The hair dyeing comb enclosure is disposed with an inlet cover and a comb head, and a stirring mechanism is disposed in the hair dyeing comb enclosure. The stirring mechanism includes a cylindrical body, stirring shafts and a driving motor; the stirring shafts are disposed in the cylindrical body, the driving motor is coupled to the stirring shafts and for driving the stirring shafts to move along an inner wall of the cylindrical body. The cylindrical body is formed with an inlet and an outlet, the inlet cover is covered on the inlet, the outlet is located at a lower side of the cylindrical body and communicated with the comb head, and an end of the outlet near the inner wall of the cylindrical body is disposed with a resilient normally open switch.

### TECHNICAL FIELD

The invention relates to the technical field of hair dyeing tools, and more particularly to a stirring-extrusion type hair dyeing comb.

### DESCRIPTION OF RELATED ART

In the existing hair dyeing technology, a hair dye is generally composed of two kinds of hair dye compositions, one is an oxidating agent such as hydrogen peroxide, and the other is an aniline dye intermediate used as a reducing agent. The two kinds of hair dye compositions should be mixed and then applied to hairs.

With the gradual development of hair care tools in the direction of household use, household hair dyeing combs have been launched on the market. At present, the hair dyeing comb on the market is equipped with two composition storage tanks in a handle of the hair dyeing comb. The composition storage tanks are used to separately receive the two kinds of hair dye compositions of the hair dye therein. The hair dyeing comb extrudes the hair dye compositions out of the respective composition storage tanks by a manner of button pressing, and then mixes the two kinds of hair dye compositions through a mixing and stirring device to form the hair dye. Afterwards, the formed hair dye is extruded from a comb head of the hair dyeing comb for hair dyeing. When using the hair dyeing comb, the hair dyeing comb needs to be pressed manually to realize the mixing, stirring and extruding of the hair dye compositions, a dosage of single extruded hair dye is small, and the dosage of hair dye extruded each time varies due to the force of manual pressing. Therefore, it is not convenient to use and the effect of hair dyeing will be affected.

### SUMMARY

In view of the above-mentioned shortcomings of the prior art, a technical problem to be solved by the invention is to provide a stirring-extrusion type hair dyeing comb.

In order to solve the above technical problem, a technical solution proposed by the invention is that a stirring-extrusion type hair dyeing comb includes a hair dyeing comb enclosure. The hair dyeing comb enclosure is disposed with an inlet cover and a comb head, and a stirring mechanism is disposed in the hair dyeing comb enclosure. The stirring mechanism includes a cylindrical body, stirring shafts and a driving motor. The stirring shafts are disposed in the cylindrical body, the driving motor is coupled to the stirring shafts and configured for driving the stirring shafts to move along an inner wall of the cylindrical body. The cylindrical body is formed with an inlet and an outlet, the inlet cover is covered on the inlet, the outlet is located at a lower side of the cylindrical body and communicated with the comb head, and an end of the outlet near the inner wall of the cylindrical body is disposed with a resilient normally open switch.

In an embodiment, the stirring shafts include a driving shaft and at least one driven shaft, the driving motor is coupled to the driving shaft, the driving shaft is located on a central axis of the cylindrical body, the driven shaft is attached onto the inner wall of the cylindrical body. One end of the driving shaft is disposed with a driving gear, or both ends of the driving shaft are disposed with the driving gears respectively. One end of the driven shaft is disposed with a driven gear, or both ends of the driven shaft are disposed with the driven gears respectively. The driving gear is correspondingly meshed with the driven gear, a location of the inner wall of the cylindrical body corresponding to the driven gear is disposed with an inner gear ring, and the driven gear is meshed with the inner gear ring.

In an embodiment, the stirring shafts include a driving shaft and at least one driven shaft, the driving motor is coupled to the driving shaft, the driving shaft is located on a central axis of the cylindrical body, the driven shaft is attached onto the inner wall of the cylindrical body, two ends of the driving shaft are fixedly connected with linkage mechanisms, the linkage mechanisms are connected with the driven shaft, and the driven shaft is rotatable around its own axis.

In an embodiment, the stirring shafts include a driving shaft and at least one driven shaft, the driving motor is coupled to the driving shaft, the driving shaft is located on a central axis of the cylindrical body, the driven shaft is attached onto the inner wall of the cylindrical body. One end of the driving shaft is disposed with a driving gear, or both ends of the driving shaft are disposed with the driving gears respectively. On end of the driven shaft is disposed with a driven gear, or both ends of the driven shaft are disposed with the driven gears respectively. The driving gear and driven gear on the same end are meshed by a transmission gear, a location of the inner wall of the cylindrical body corresponding to the driven gear is disposed with an inner gear ring, and the driven gear is meshed with the inner gear ring.

In an embodiment, the both ends of the driving shaft and the both ends of the driven shaft are connected with linkage mechanisms, and the linkage mechanisms are configured for maintaining a distance between the driving shaft and the driven shaft.

In an embodiment, the driving shaft and the driven shaft have a belt structure disposed thereon, and the belt structure is sleeved on outer surfaces of the driving shaft and the driven shaft.

In an embodiment, wherein the driving shaft and the driven shaft have different diameters.

In an embodiment, the driven shaft comprises a driven inner shaft and a driven outer shaft, the driven inner shaft is fixedly connected with the driven outer shaft, the driven inner shaft is made of a cemented carbide material, and the driven outer shaft is made of an elastic material.

In an embodiment, the inlet cover is located at an upper side of the hair dyeing comb enclosure, and a shape of the inlet cover is an elongated shape.

In an embodiment, the comb head is a detachable structure.

In an embodiment, the driving motor is powered by a battery or a power adapter.

In an embodiment, the hair dyeing comb enclosure includes a stirring head and a handle, the stirring head and the handle are detachable from each other, the cylindrical body and the stirring shafts are disposed in the stirring head, and the driving motor is disposed in the handle.

In an embodiment, an end of the handle near the stirring head is disposed with a locking ring, an inner surface of the locking ring is disposed with engagement protrusions, an end of the stirring head near the handle is disposed with an engagement ring, an outer surface of the engagement ring is disposed with L-shaped engagement grooves, the engagement protrusions are fitted into the L-shaped engagement grooves and rotated for locking.

In an embodiment, an end surface of the stirring head near the handle is disposed concave engagement grooves, a protruded resilient engagement block and a first transmission shaft hole; a resilient push is disposed at the bottom of the end surface of the stirring head near the handle and fixedly connected with the resilient engagement block, the resilient engagement block is resiliently protruded outwardly, the first transmission shaft hole is located at a middle position, and the concave engagement grooves are arranged on a periphery of the first transmission shaft hole; an end surface of the handle near the stirring head is disposed with L-shaped engagement protrusions, a recess and a second transmission shaft hole; positions of the L-shaped engagement protrusions are corresponding to that of the concave engagement grooves, a position of the recess is corresponding to that of the resilient engagement block, and a position of the second transmission shaft hole is corresponding to that of the first transmission shaft hole.

In an embodiment, a periphery of an end of the stirring head near the handle is provided with a baffle.

Beneficial effects of the invention are as follows: (1) the stock of hair dye in the hair dyeing comb is sufficient and two kinds of hair dye compositions can be stirred evenly; (2) the hair dyeing comb can extrude the hair dye quantitatively, sufficiently and efficiently; (3) the hair dyeing comb is driven by electricity and does not need to be pressed manually; (4) the stirring mechanism can fully extrude the hair dye out, and thus a residual amount of hair dye in the cylindrical body is small; and (5) the stirring head and the handle of the hair dyeing comb are detachable from each other, the handle can be installed with stirring heads respectively containing different colors of hair dyes, which can avoid color mixing and facilitate separation and cleaning.

### BRIEF DESCRIPTION OF THE DRAWINGS

FIG. 1 is a schematic view of an overall structure of a first embodiment of the invention.

FIG. 2 is a schematic view of an exploded structure of the first embodiment of the invention.

FIG. 3 is an exploded schematic structural view of a first-type structure of a stirring mechanism of the first embodiment of the invention.

FIG. 4 is a schematic cross-sectional view of a cylindrical body of the first-type structure of the stirring mechanism of the first embodiment of the invention.

FIG. 5 is an exploded schematic structural view of a second-type structure of the stirring mechanism of the first embodiment of the invention.

FIG. 6 is a schematic cross-sectional view of a cylindrical body of the second-type structure of the stirring mechanism of the first embodiment of the invention.

FIG. 7 is a schematic structural view of a connection between a press switch and a comb head of the first embodiment of the invention.

FIG. 8 is a schematic view of an overall structure of a second embodiment of the invention.

FIG. 9 is a schematic structural view of a stirring head and a handle in a disassembled state of the second embodiment of the invention.

FIG. 10 is an exploded schematic structural view of a stirring mechanism of the second embodiment of the invention.

FIG. 11 is a schematic cross-sectional view of the stirring mechanism of the second embodiment of the invention.

FIG. 12 is a schematic view of an overall structure of a third embodiment of the invention.

FIG. 13 is a schematic structural view of a stirring head and a handle in a disassembled state of the third embodiment of the invention.

### DESCRIPTION OF NUMERICAL REFERENCES IN DRAWINGS

100, hair dyeing comb enclosure; 101, upper casing; 102, lower casing; 103, inlet cover; 104, comb head; 1041, comb tooth; 1042, first hook; 105: battery cover; 106, battery; 107, enable switch; 108, press switch; 1081, spring; 1082, second hook; 109, stirring head; 110, handle; 111, locking ring; 1111, engagement protrusion; 112, engagement ring; 1121, L-shaped engagement groove; 113, concave engagement slot; 114, resilient engagement block; 115, first transmission shaft hole; 116, resilient push; 117, L-shaped engagement protrusion; 118, recess; 119, second transmission shaft hole; 120, baffle; 200, stirring mechanism; 201, cylindrical body; 202, driving shaft; 203, driven shaft; 2031, driven inner shaft; 2032, driven outer shaft; 204, driving motor; 205, inlet; 206, outlet; 207, resilient normally open switch; 208, driving gear; 209, driven gear; 210, inner gear ring; 211, linkage mechanism; 212, transmission gear; 213, belt structure.

### DETAILED DESCRIPTION OF EMBODIMENTS

The invention is further described in detail with reference to accompanying drawings.

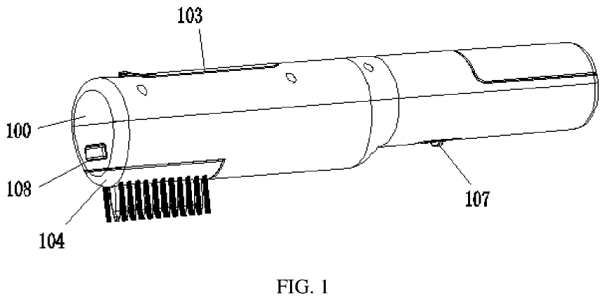

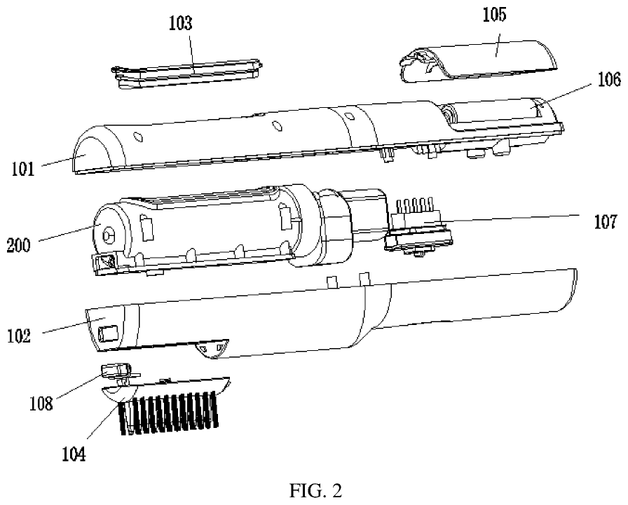

FIG. 1 and FIG. 2 show a first embodiment of a stirring-extrusion type hair dyeing comb, and a main body of the hair dyeing comb is a hair dyeing comb enclosure 100. The hair dyeing comb enclosure 100 includes an upper casing 101 and a lower casing 102. The upper casing 101 and the lower casing 102 are engaged with (e.g., buckled with) each other. An upper side of the upper casing 101 is disposed with an inlet cover (also referred to as cylindrical body cover) 103, and a lower side of the lower casing 102 is disposed with a comb head 104. A stirring mechanism 200 is disposed between the upper casing 101 and the lower casing 102. The upper casing 101 is further formed with a battery chamber, and the battery chamber has a battery 106 received therein. The battery chamber is covered by a battery cover 105. The stirring mechanism 200 is powered by the battery 106. An enable switch 107 is connected between the stirring mechanism 200 and the battery 106 and used for controlling the stirring mechanism 200 to run or stop.

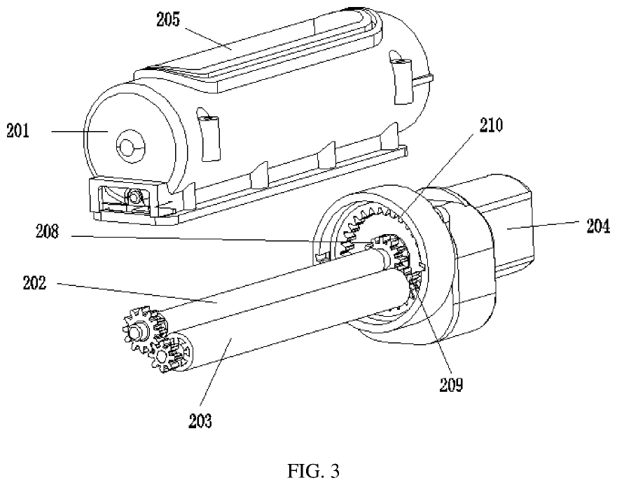

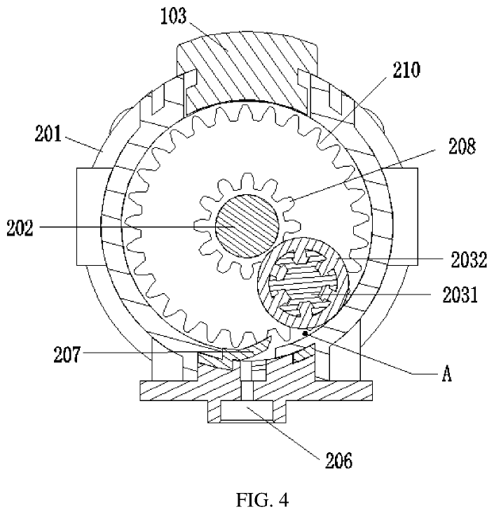

FIG. 3 and FIG. 4 show a first-type structure of the stirring mechanism 200 of the stirring-extrusion type hair dyeing comb. The stirring mechanism 200 includes a cylindrical body 201, a driving shaft 202, a driven shaft 203 and a driving motor 204. An upper side of the cylindrical body 201 is formed with an inlet (also referred to as feed port) 205, a size of the inlet 205 is matched with that of the inlet cover 103, and the hair dyeing comb is added a hair dye into the cylindrical body 201 by opening the inlet cover 103. A lower side of the cylindrical body 201 is formed with an outlet (also referred to as discharge port) 206, and the outlet 206 is communicated with the comb head 104. An end of the outlet 206 near an inner wall of the cylindrical body 201 is disposed with an resilient normally open switch 207, and one end of the resilient normally open switch 207 is warped inwardly, so that the outlet 206 is in a normally open state. The driving motor 204 is arranged on one side of a circular end face of the cylindrical body 201. The driving shaft 202 and the driven shaft 203 are arranged in the cylindrical body 201. The driving motor 204 is connected with the driving shaft 202. The driving shaft 202 is located on a central axis of cylindrical body 201. One or both ends of the driving shaft 202 is/are provided with a driving gear(s) 208, and the driving motor 204 is used for driving the driving shaft 202 and the driving gear(s) 208 to rotate together. Correspondingly, one or both ends of the driven shaft 203 is/are provided with a driven gear(s) 209, the driven shaft 203 and the driven gear(s) 209 rotate together, and the driving gear(s) 208 is/are meshed with the driven gear(s) correspondingly. On the inner wall of the cylindrical body 201, a location corresponding to the driven gear 209 is disposed with an inner gear ring 210. The driven gear 209 is meshed with the inner gear ring 210. The driven shaft 203 is tightly attached to the inner wall of the cylindrical body 201 after being assembled.

When the driving motor 204 runs, the driving motor 204 drives the driving shaft 202 and the driving gear(s) 208 to rotate, taking the illustration of FIG. 4 as an example, the driving shaft 202 and the driving gear 208 rotate clockwise, under the driving of the driving gear 208, the driven shaft 203 and the driven gear 209 rotate anti-clockwise around their own axes. Since the driven gear 209 and the inner gear ring 210 are meshed with each other, the driven shaft 203 and the driven gear 209 rotate clockwise with an axis of the driving shaft 202 as the rotation center. During the self-rotations of the driving shaft 202 and the driven shaft 203 and the revolution of the driven shaft 203 around the driving shaft 202, the hair dye contained in the cylindrical body 201 would be stirred. When the driven shaft 203 revolves around the driving shaft 202, most of the hair dye concentrates at the front end of the revolution direction of the driven shaft 203, combining the self-rotation of the driven shaft 203, the hair dye concentrates to the position of point A at the front end of the driven shaft 203. When the driven shaft 203 revolves to the outlet 206 at the lower side of the cylindrical body 201, the hair dye is pushed into the opening of the resilient normally open switch 207, the driven shaft 203 then squeezes the resilient normally open switch 207 to extrude out the hair dye. The driven shaft 203 revolves one cycle would extrude out a certain amount of hair dye, and the hair dye is quantitatively delivered to the comb head 104 and then extruded out from the comb teeth 1041 of the comb head 104. The driving motor 204 can also operate in a reverse direction, with the comb head 104 of the hair dyeing comb facing upward and the driving motor 204 runs reversely to pre-stir the hair dye, the hair dye will not be extruded from the opening of the resilient normally open switch 207.

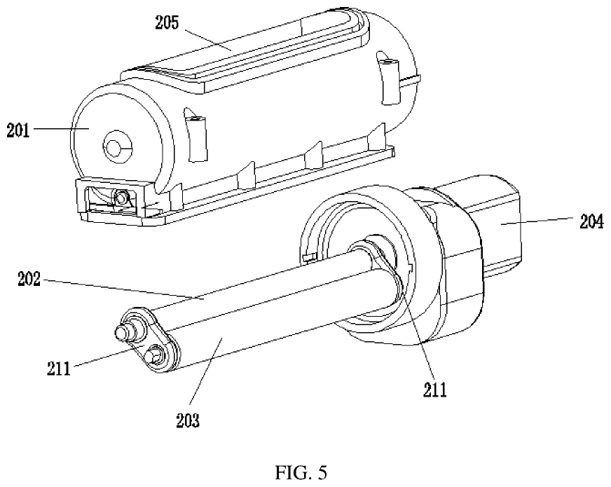

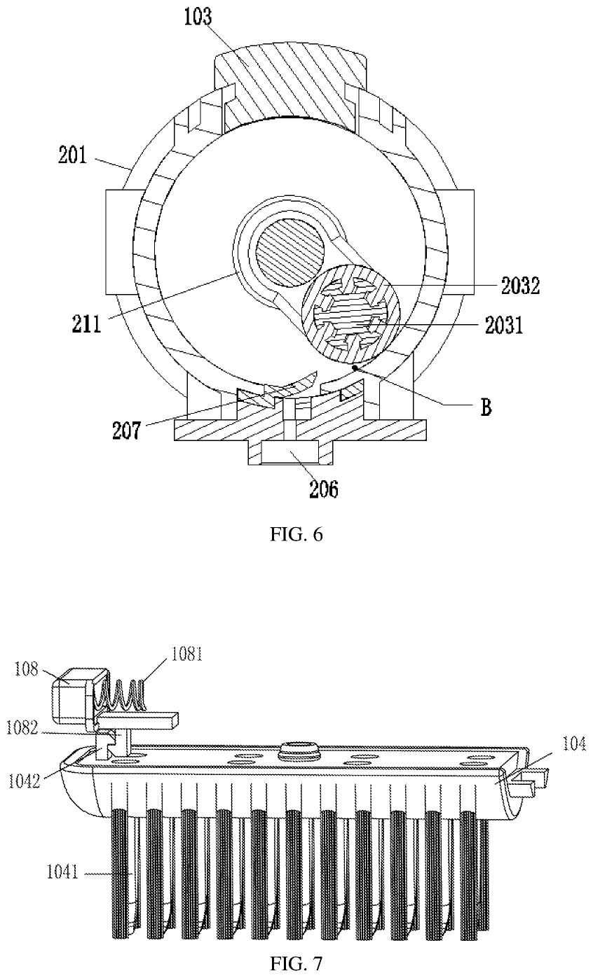

FIG. 5 and FIG. 6 show a second-type structure of the stirring mechanism 200 of the stirring-extrusion type hair dyeing comb. In particular, the stirring mechanism 200 includes the cylindrical body 201, the driving shaft 202, the driven shaft 203 and the driving motor 204. The upper side of the cylindrical body 201 is formed with the inlet 205, the size of the inlet 205 is matched with that of the inlet cover 103, and the hair dyeing comb is added a hair dye into the cylindrical body 201 by opening the inlet cover 103. The lower side of the cylindrical body 201 is formed with the outlet 206, and the outlet 206 is communicated with the comb head 104. The end of the outlet 206 near the inner wall of the cylindrical body 201 is disposed with the resilient normally open switch 207, and one end of the resilient normally open switch 207 is warped inwardly, so that the outlet 206 is in a normally open state. The driving motor 204 is arranged on one side of the circular end face of the cylindrical body 201. The driving shaft 202 and the driven shaft 203 are arranged in the cylindrical body 201. The driving motor 204 is connected with the driving shaft 202. The driving shaft 202 is located on a central axis of the cylindrical body 201. Both ends of the driving shaft 202 are provided with linkage mechanisms 211, and the linkage mechanisms 211 also are connected with the driven shaft 203. The driven shaft 203 can rotate around an axis center itself. The driven shaft 203 is tightly attached onto the inner wall of the cylindrical body 201. The linkage mechanisms 211 at both ends can realize a transmission between the driving shaft 202 and the driven shaft 203, and maintain a distance between the driving shaft 202 and the driven shaft 203 so as to avoid a displacement of the driven shaft 203.

When the driving motor 204 runs, the driving motor 204 drives the driving shaft 202 to rotate, taking the illustration of FIG. 6 as an example, the driving shaft 202 rotates clockwise, under the transmission of the linkage mechanisms 211, the driven shaft 203 rotates clockwise with an axis of the driving shaft 202 as the rotation center (the driven shaft 203 revolves). When the driven shaft 203 revolves, a frictional resistance is generated between the inner wall of the cylindrical body 201 and the driven shaft 203, which makes the driven shaft 203 rotates counterclockwise around its own axis (the driven shaft 203 self-rotates). During the self-rotations of the driving shaft 202 and the driven shaft 203 and the revolution of the driven shaft 203 around the driving shaft 202, the hair dye contained in the cylindrical body 201 would be stirred. When the driven shaft 203 revolves around the driving shaft 202, most of the hair dye concentrates at the front end of the revolution direction of the driven shaft 203, combining the self-rotation of the driven shaft 203, the hair dye concentrates to the position of point B at the front end of the driven shaft 203. When the driven shaft 203 revolves to the outlet 206 at the lower side of the cylindrical body 201, the hair dye is pushed into the opening of the resilient normally open switch 207, the driven shaft 203 then squeezes the resilient normally open switch 207 to extrude out the hair dye. The driven shaft 203 revolves one cycle would extrude out a certain amount of hair dye, and the hair dye is quantitatively delivered to the comb head 104 and then extruded out from the comb teeth 1041 of the comb head 104. The driving motor 204 can also operate in a reverse direction, with the comb head 104 of the hair dyeing comb facing upward and the driving motor 204 runs reversely to pre-stir the hair dye, the hair dye will not be extruded from the opening of the resilient normally open switch 207.

Preferably, in the above two type structures of the stirring structure 200, the driving shaft 202 and the driven shaft 203 have different diameters, and the diameter of the driving shaft 202 is smaller than the diameter of the driven shaft 203. When angular velocities of the driving shaft 202 and the driven shaft 203 are the same, linear velocities of surfaces of the driving shaft 202 and the driven shaft 203 would be different from each other, a closest gap between the driving shaft 202 and the driven shaft 203 is not easy to extrude the hair dye, and thus the hair dye is stirred more evenly.

Preferably, in the above two type structures of the stirring structure 200, the driven shaft 203 includes a driven inner shaft 2031 and a driven outer shaft 2032. The driven inner shaft 2031 is fixedly connected with the driven outer shaft 2032. The driven inner shaft 2031 is made of a cemented carbide material, such as a tungsten-cobalt cemented carbide, a tungsten-titanium-cobalt cemented carbide, a tungsten-titanium-tantalum (niobium) cemented carbide, etc. The driven outer shaft 2032 is made of an elastic material, such as silicone, rubber, etc.

Preferably, the inlet cover 103 is disposed on the upper side of the hair dyeing comb enclosure 100, and a shape of the inlet cover 103 is an elongated shape. A shape of the inlet 205 is matched with that of the inlet cover 103, and the hair dye can be evenly fed into the cylindrical body 201 through the elongated inlet 205, which is helpful to the stirring of the driving shaft 202 and the driven shaft 203.

Preferably, the comb head 104 is a detachable structure. Combined with the illustrations of FIG. 1, FIG. 2 and FIG. 7, a press switch 108 is disposed at the front end of the lower casing 102, the comb head 104 is disposed with a first hook 1042, the press switch 108 is disposed with a spring 1081 and a second hook 1082, the spring 1081 is used for being pressing to reset, and the first hook 1042 is engageable with the second hook 1082 to install the comb head 104 onto the lower side of the lower casing 102. By pressing the press switch 108, the comb head 104 is installed or removed.

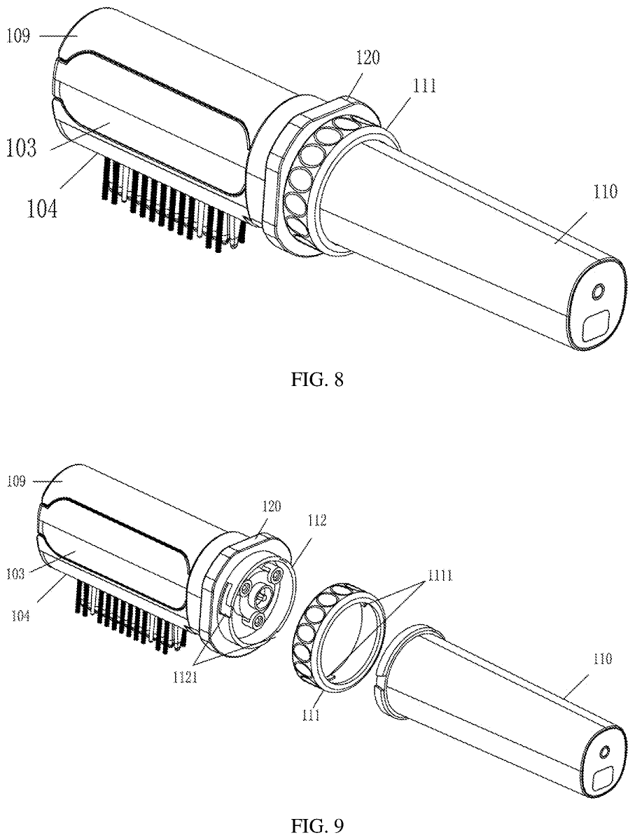

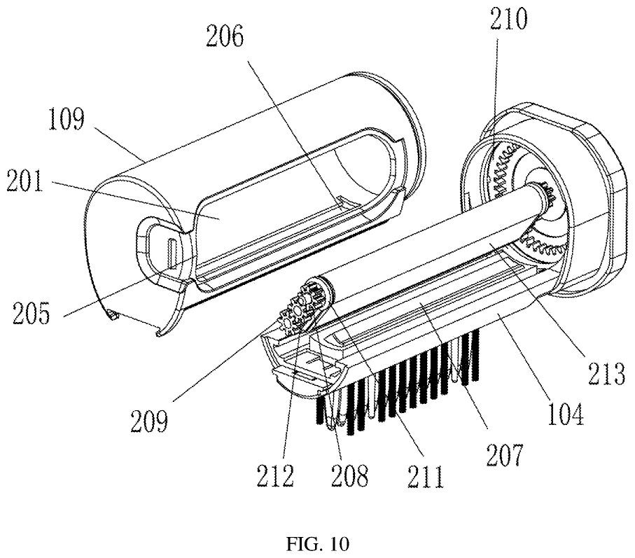

FIG. 8 through FIG. 11 show a second embodiment of the stirring-extrusion type hair dyeing comb, and a main body of the stirring-extrusion type hair dyeing comb is a hair dyeing comb enclosure. Specifically, the hair dyeing comb enclosure includes a stirring head 109 and a handle 110. The stirring head 109 and the handle 110 are detachable from each other. An end of the handle 110 near the stirring head 109 is disposed with a locking ring 111, and an inner surface of the locking ring 110 is disposed with engagement protrusions 1111. An end of the stirring head 109 near the handle 110 is disposed with an engagement ring 112, and an outer surface of the engagement ring 112 is disposed with L-shaped engagement grooves 1121. An inner diameter of the locking ring 111 is equal to or slightly larger than an outer diameter of the engagement ring 112. The engagement protrusions 1111 are matched with the L-shaped engagement grooves 1121, and the engagement protrusions 1111 fit into the L-shaped engagement grooves 1121 and then are rotated for locking.

A lateral side of the stirring head 109 is disposed with the inlet cover 103, and a lower side of the stirring head 109 is disposed with the comb head 104. The comb head 104 is a detachable structure. The stirring mechanism 200 and the battery for driving the stirring mechanism 200 to operate are arranged in the hair dyeing comb enclosure. An enable switch is connected between the stirring mechanism 200 and the battery and used for controlling the stirring mechanism 200 to run or stop.

The periphery of the end of the stirring head 109 near the handle 100 is further provided with a baffle 120. When the hair dyeing comb is used to dye the hair, the baffle 120 can block a small amount of hair dye overflowing from the comb head, so as to prevent the hair dye from flowing along the stirring head 109 to the handle 110 and contaminate the user's hand.

In the second embodiment, a third-type structure of the stirring mechanism 200 of the stirring-extrusion type hair dyeing comb is provided. In particular, the stirring mechanism 200 includes the cylindrical body 201, the driving shaft 202, the driven shaft 203 and the driving motor. The cylindrical body 201 and the stirring head 109 are an integrally-formed structure, which can be understood as that the stirring head 109 has a hollow cylindrical body 201. The lateral side of the cylindrical body 201 is formed with the inlet 205, the inlet cover 103 is covered on the inlet 205, and the hair dyeing comb can be added a hair dye into the cylindrical body 201 by opening the inlet cover 103. The lower side of the cylindrical body 201 is formed with the outlet 206, and the outlet 206 is connected with the comb head 104. The end of the outlet 206 near the inner wall of the cylindrical body 201 is disposed with the resilient normally open switch 207, and one end of the resilient normally open switch 207 is warped inwardly so that the outlet 206 is in a normally open state. The driving shaft 202 and the driven shaft 203 are arranged in the cylindrical body 201, the driving motor and the battery are arranged in the handle 110. The battery is connected with the driving motor to supply power. The driving motor is connected with the driving shaft 202, the driving shaft 203 is located at a central axis of the cylindrical body 201, two ends of the driving shaft 202 are provided with driving gears 208, the driving motor drives the driving shaft 202 and the driving gears 208 to rotate together. Two ends of the driven shaft 203 are provided with driven gears 209, and the driven shaft 203 and the driven gears 209 rotate together. The driving gear 208 and the driven gear 209 located at the same end have a transmission gear 212 arranged therebetween. The transmission gear 212 is meshed with the driving gear 208 and the driven gear 209 individually. On the inner wall of the cylindrical body 201, a location corresponding to the driven gear 209 is provided with the inner gear ring 210, and the driven gear 209 is meshed with the inner gear ring 210. The driven shaft 203 is tightly attached onto the inner wall of the cylindrical body 201 after being assembled. In order to improve parallelism and stability between the driving shaft 202 and the driven shaft 203, both ends of the driving shaft 202 and the driven shaft 203 are connected with linkage mechanisms 211. The linkage mechanisms 211 are used for maintaining a distance between the driving shaft 202 and the driven shaft 203, so that an overall distance between the driving shaft 202 and the driven shaft 203 is identical. The linkage mechanisms 211 herein are not fixed with the driving shaft 202 and thus are not used as a transmission component. In order to improve extrusion effect of the hair dyeing comb, a belt structure 213 is disposed on the driving shaft 202 and the driven shaft 203. The belt structure 213 is tightly sleeved on outer surfaces of the driving shaft 202 and the driven shaft 203, and rotates with the rotations of the driving shaft 202 and the driven shaft 203.

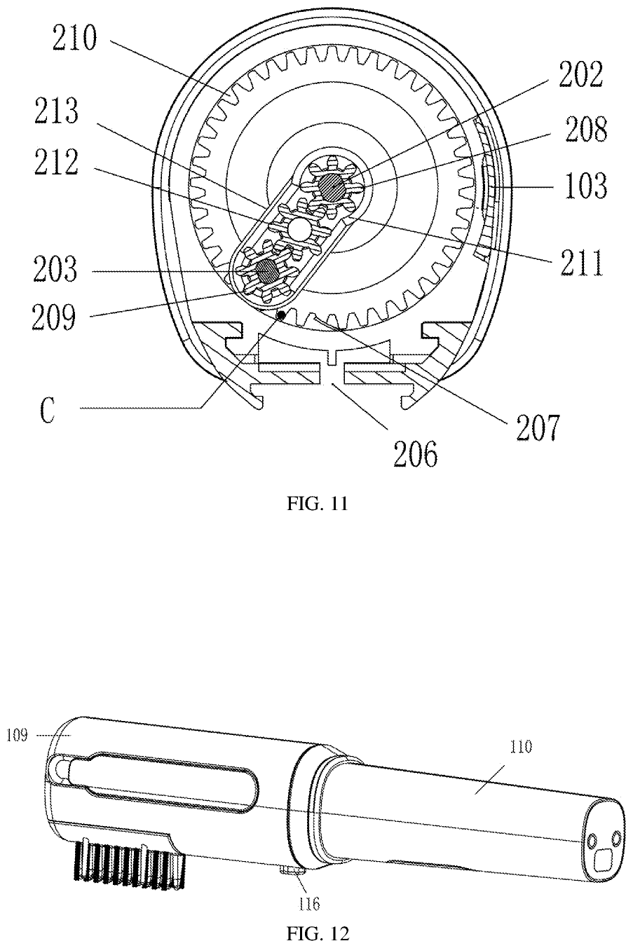

When the driving motor 204 runs, the driving motor 204 drives the driving shaft 202 to rotate, taking the illustration of FIG. 11 as an example, the driving shaft 202 and the driving gears 208 rotate clockwise, under the transmission of the transmission gears 212, the driven shaft 203 and the driven gears 209 rotate clockwise around their own axes. Since the driven gears 209 and the inner gear ring 210 are meshed with each other, the driven shaft 203 and the driven gears 209 rotate anti-clockwise with an axis of the driving shaft 202 as the rotation center. During the self-rotations of the driving shaft 202 and the driven shaft 203 and the revolution of the driven shaft 203 around the driving shaft 202, the hair dye contained in the cylindrical body 201 would be stirred. When the driven shaft 203 revolves around the driving shaft 202, most of the hair dye concentrates at the front end of the revolution direction of the driven shaft 203, combining the self-rotation of the driven shaft 203, the hair dye concentrates to the position of point C at the front end of the driven shaft 203. When the driven shaft 203 revolves to the outlet 206 at the lower side of the cylindrical body 201, the hair dye is pushed into the opening of the resilient normally open switch 207, the driven shaft 203 then squeezes the resilient normally open switch 207 to extrude out the hair dye. The driven shaft 203 revolves one cycle would extrude out a certain amount of hair dye, and the hair dye is quantitatively delivered to the comb head 104 and then extruded out from the comb teeth 1041 of the comb head 104. The driving motor 204 can also operate in a reverse direction, with the comb head 104 of the hair dyeing comb facing upward and the driving motor 204 runs reversely to pre-stir the hair dye, the hair dye will not be extruded from the opening of the resilient normally open switch 207.

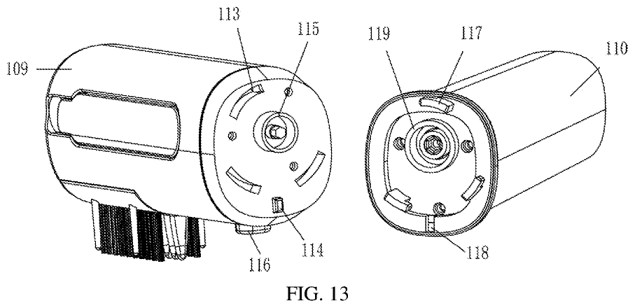

FIG. 12 and FIG. 13 show a third embodiment of the stirring-extrusion type hair dyeing comb, and a main body of the hair dyeing comb is a hair dyeing comb enclosure. Specifically, the hair dyeing comb enclosure includes the stirring head 109 and the handle 110. The stirring head 109 and the handle 110 are detachable from each other. An end surface of the stirring head 109 near the handle 110 is formed with concave engagement grooves 113, a protruded resilient engagement block 114 and a first transmission shaft hole 115. At the bottom of the end surface of the stirring head 109 near the handle 110 is formed with an resilient push 116. The resilient engagement block 114 is located near the bottom of the end surface, and the resilient push 116 is fixedly connected with the resilient engagement block 114 inside the stirring head 109. The resilient push 116 and the resilient engagement block 114 are squeezed by a compression spring, and the resilient engagement block 114 is kept pushing out towards handle 110 without an external force applied to the resilient push 116. The first transmission shaft hole 115 is located at the middle position, the concave engagement grooves are centered on the first transmission shaft hole 115 and are equidistantly arranged on the periphery of the first transmission shaft hole 115. An end surface of the handle 110 near the stirring head 109 is provided with L-shaped engagement protrusions 117, a recess 118 and a second transmission shaft hole 119. The positions of the L-shaped engagement protrusions 117 are corresponding to that of the concave engagement grooves 113, the position of the recess 118 is corresponding to that of the resilient engagement block 114, and the position of the second transmission shaft hole 119 is corresponding to that of the first transmission shaft hole 115.

When connecting the stirring head 109 with the handle 110, the first transmission shaft hole 115 is aligned with the second transmission shaft hole 119, the L-shaped engagement protrusions 117 are aligned with the concave engagement grooves 113 respectively, and the stirring head 109 and the handle 110 are tightly attached. At this time, the L-shaped engagement protrusions 117 enter into the concave engagement grooves 113 respectively, and the resilient engagement block 114 is compressed. After the stirring head 109 and the handle 110 are made to rotate relative to each other, the L-shaped engagement protrusions 117 and the concave engagement grooves 113 are locked to each other, and the rotated resilient engagement block 114 is just aligned with the recess 118, and the resilient engagement block 114 is snapped into the recess 118. So far, the connection of the stirring head 109 with the handle 110 is completed. When it is expected to separate the stirring head 109 and the handle 110, pushing the resilient push 116 by hand to separate the resilient engagement block 114 from the recess 118, and then rotating the stirring head 109 relative to the handle 110 to thereby unlock the L-shaped engagement protrusions 117 and the concave engagement grooves 113, the stirring head 109 and the handle 110 are separated consequently.

In the third embodiment, the other internal structures of the hair dyeing comb enclosure are the same as those of the second embodiment, and thus will not be repeated herein.

Moreover, the driving motor 204 of the stirring-extrusion type hair dyeing comb in any one of the above embodiments is driven by the battery, and in other embodiment the driving motor 204 of the stirring-extrusion type hair dyeing comb may be driven by a power adapter instead, which does not affect the use function of the stirring-extrusion type hair dyeing comb.

The above embodiments are only to illustrate rather than limit the invention. Therefore, all equivalent changes or modifications made according to the content described in the patent application scope of the invention should be included in the protection scope of the invention.

What is claimed is:

1. A stirring-extrusion type hair dyeing comb comprising a hair dyeing comb enclosure, wherein the hair dyeing comb enclosure is disposed with an inlet cover and a comb head, and a stirring mechanism is disposed in the hair dyeing comb enclosure; the stirring mechanism comprises a cylindrical body, stirring shafts and a driving motor; the stirring shafts are disposed in the cylindrical body, the driving motor is coupled to the stirring shafts and configured for driving the stirring shafts to move along an inner wall of the cylindrical body; the cylindrical body is formed with an inlet and an outlet, the inlet cover is covered on the inlet, the outlet is located at a lower side of the cylindrical body and communicated with the comb head, and an end of the outlet near the inner wall of the cylindrical body is disposed with a resilient normally open switch.

2. The stirring-extrusion type hair dyeing comb as claimed in claim 1, wherein the stirring shafts comprise a driving shaft and at least one driven shaft, the driving motor is coupled to the driving shaft, the driving shaft is located on a central axis of the cylindrical body, the driven shaft is attached onto the inner wall of the cylindrical body, at least one end of the driving shaft is disposed with a driving gear, at least one end of the driven shaft is disposed with a driven gear, the driving gear is correspondingly meshed with the driven gear, a location of the inner wall of the cylindrical body corresponding to the driven gear is disposed with an inner gear ring, and the driven gear is meshed with the inner gear ring.

3. The stirring-extrusion type hair dyeing comb as claimed in claim 1, wherein the stirring shafts comprise a driving shaft and at least one driven shaft, the driving motor is coupled to the driving shaft, the driving shaft is located on a central axis of the cylindrical body, the driven shaft is attached onto the inner wall of the cylindrical body, two ends of the driving shaft are fixedly connected with linkage mechanisms, the linkage mechanisms are connected with the driven shaft, and the driven shaft is rotatable around its own axis.

4. The stirring-extrusion type hair dyeing comb as claimed in claim 1, wherein the stirring shafts comprise a driving shaft and at least one driven shaft, the driving motor is coupled to the driving shaft, the driving shaft is located on a central axis of the cylindrical body, the driven shaft is attached onto the inner wall of the cylindrical body, at least one end of the driving shaft is disposed with a driving gear, at least one end of the driven shaft is disposed with a driven gear, the driving gear and the driven gear are meshed by a transmission gear, a location of the inner wall of the cylindrical body corresponding to the driven gear is disposed with an inner gear ring, and the driven gear is meshed with the inner gear ring.

5. The stirring-extrusion type hair dyeing comb as claimed in claim 4, wherein the both ends of the driving shaft and the both ends of the driven shaft are connected with linkage mechanisms, and the linkage mechanisms are configured for maintaining a distance between the driving shaft and the driven shaft.

6. The stirring-extrusion type hair dyeing comb as claimed in claim 4, wherein the driving shaft and the driven shaft have a belt structure disposed thereon, and the belt structure is sleeved on outer surfaces of the driving shaft and the driven shaft.

7. The stirring-extrusion type hair dyeing comb as claimed in claim 2, wherein the driving shaft and the driven shaft have different diameters.

8. The stirring-extrusion type hair dyeing comb as claimed in claim 3, wherein the driving shaft and the driven shaft have different diameters.

9. The stirring-extrusion type hair dyeing comb as claimed in claim 2, wherein the driven shaft comprises a driven inner shaft and a driven outer shaft, the driven inner shaft is fixedly connected with the driven outer shaft, the driven inner shaft is made of a cemented carbide material, and the driven outer shaft is made of an elastic material.

10. The stirring-extrusion type hair dyeing comb as claimed in claim 3, wherein the driven shaft comprises a driven inner shaft and a driven outer shaft, the driven inner shaft is fixedly connected with the driven outer shaft, the driven inner shaft is made of a cemented carbide material, and the driven outer shaft is made of an elastic material.

11. The stirring-extrusion type hair dyeing comb as claimed in claim 1, wherein the inlet cover is located at an upper side of the hair dyeing comb enclosure, and a shape of the inlet cover is an elongated shape.

12. The stirring-extrusion type hair dyeing comb as claimed in claim 1, wherein the comb head is a detachable structure.

13. The stirring-extrusion type hair dyeing comb as claimed in claim 1, wherein the driving motor is powered by a battery or a power adapter.

14. The stirring-extrusion type hair dyeing comb as claimed in claim 1, wherein the hair dyeing comb enclosure comprises a stirring head and a handle, the stirring head and the handle are detachable from each other, the cylindrical body and the stirring shafts are disposed in the stirring head, and the driving motor is disposed in the handle.

15. The stirring-extrusion type hair dyeing comb as claimed in claim 14, wherein an end of the handle near the stirring head is disposed with a locking ring, an inner surface of the locking ring is disposed with engagement protrusions, an end of the stirring head near the handle is disposed with an engagement ring, an outer surface of the engagement ring is disposed with L-shaped engagement grooves, the engagement protrusions are fitted into the L-shaped engagement grooves and rotated for locking.

16. The stirring-extrusion type hair dyeing comb as claimed in claim 14, wherein an end surface of the stirring head near the handle is disposed concave engagement grooves, a protruded resilient engagement block and a first transmission shaft hole; a resilient push is disposed at the bottom of the end surface of the stirring head near the handle and fixedly connected with the resilient engagement block, the resilient engagement block is resiliently protruded outwardly, the first transmission shaft hole is located at a middle position, and the concave engagement grooves are arranged on a periphery of the first transmission shaft hole; an end surface of the handle near the stirring head is disposed with L-shaped engagement protrusions, a recess and a second transmission shaft hole;
positions of the L-shaped engagement protrusions are corresponding to that of the concave engagement grooves, a position of the recess is corresponding to that of the resilient engagement block, and a position of the second transmission shaft hole is corresponding to that of the first transmission shaft hole.

17. The stirring-extrusion type hair dyeing comb as claimed in claim 14, wherein a periphery of an end of the stirring head near the handle is provided with a baffle.
